(19) United States
(12) Patent Application Publication
(10) Pub. No.: US 2002/0062589 A1
(43) Pub. Date: May 30, 2002

(54) Illuminated vehicle-mounted advertising sign

(76) Inventor: Don Miller, Middlebury, IN (US)

Correspondence Address: BAKER & DANIELS, 205 W. JEFFERSON BOULEVARD, SUITE 250, SOUTH BEND, IN, 46601, US

(21) Appl. No.: 09/725,703

(22) Filed: Nov. 29, 2000

(51) Int. Cl. G09F 21/04

(52) U.S. Cl. 40/592

(57) ABSTRACT

An advertising sign including a frame having a pair of ends, a pair of sides, a pair of advertising panels, and a plurality of lighting cartridges. The sides face different directions and the ends include slots that allow the insertion of the advertising panels into the sign through the ends. The lighting cartridges are also inserted into the sign through the ends and are located behind the advertising panels to back light the advertising panels in a substantially uniform manner.

### FIELD OF THE INVENTION

The present invention generally relates to vehicle-mounted advertising signs and more particularly to an illuminated, vehicle-mounted advertising sign with easily removable advertising panels and lighting cartridges which illuminate the advertising panels from within the sign in a bright and substantially uniform manner

### BACKGROUND OF THE INVENTION

The use of vehicles, such as taxicabs, vans, and buses, to carry advertising signs is well known. These signs are often mounted to the tops of the vehicles to display the advertisement to both pedestrians and motorists. Many vehicle-mounted advertising signs are illuminated to further attract the attention of the public, and to allow the displayed advertisements to be seen at night.

Sign owners often rent the advertising space on the advertising panels. However, conventional advertising signs generally provide advertising panels that are not readily removable from the sign. Such panels are not desirable because any significant disassembly required to change the displayed advertisement may result in increased operating expenses and downtime for both the vehicle and the advertising sign.

Conventional advertising signs often require similarly significant disassembly to repair the lighting system. When a light bulb burns out, the entire sign is unsightly, and the advertising space on the sign may be difficult to see at night. Thus, repairs to the lighting system should be made immediately following any failure or burn out. Again, any significant disassembly required to change bulbs or make other repairs may represent increased costs and downtime for the vehicle and advertising sign.

Generally, the larger the advertising space on the sign, the better. Larger signs are more conspicuous and may permit increased rental fees. However, it is difficult to uniformly illuminate very large advertising panels with the limited power resources available on many vehicles. Non-uniform illumination clearly detracts from the overall appearance of the sign. Thus, a need exists for a lighting system for a vehicle-mounted advertising sign which is capable of uniformly illuminating a large advertising space.

### SUMMARY OF THE INVENTION

The present invention provides a vehicle-mounted advertising sign having a frame which defines two sides extending between two ends. Each side has upper and lower grooves for supporting an advertising panel which is easily inserted and removed through a slot formed on one of the ends of the sign. The advertising panels are protected by a pair of corresponding transparent covers which each span an entire side of the sign to prevent damage to the advertising panels. The advertising sign further includes lighting cartridges that are supported in parallel relationship to the advertising panels by channels within the sign frame. The lighting cartridges may be inserted and removed through the ends of the sign with minimal disassembly to facilitate repairs and bulb replacement. The bulbs mounted to the lighting cartridges are spaced relative to one another and relative to the advertising panels to provide substantially uniform back lighting of the panels.

### BRIEF DESCRIPTION OF THE DRAWINGS

FIG. 1 is a perspective view of an advertising sign according to the present invention mounted on a vehicle.

FIG. 2 is a perspective view of a sign frame according to the present invention.

FIG. 3 is an end, elevational view of an advertising sign according to the present invention.

FIG. 4 is an exploded, partially fragmented, perspective view of an advertising sign according to the present invention.

FIG. 5 is a perspective view of an advertising sign according to the present invention showing the insertion of an advertising panel.

FIG. 6 is a perspective view of a sign frame according to another embodiment of the present invention.

### DETAILED DESCRIPTION OF EMBODIMENTS OF THE INVENTION

The embodiments of the invention described herein are not intended to be exhaustive or to limit the invention to the precise forms disclosed. Rather, the embodiments selected for description have been chosen to enable one skilled in the art to practice the invention.

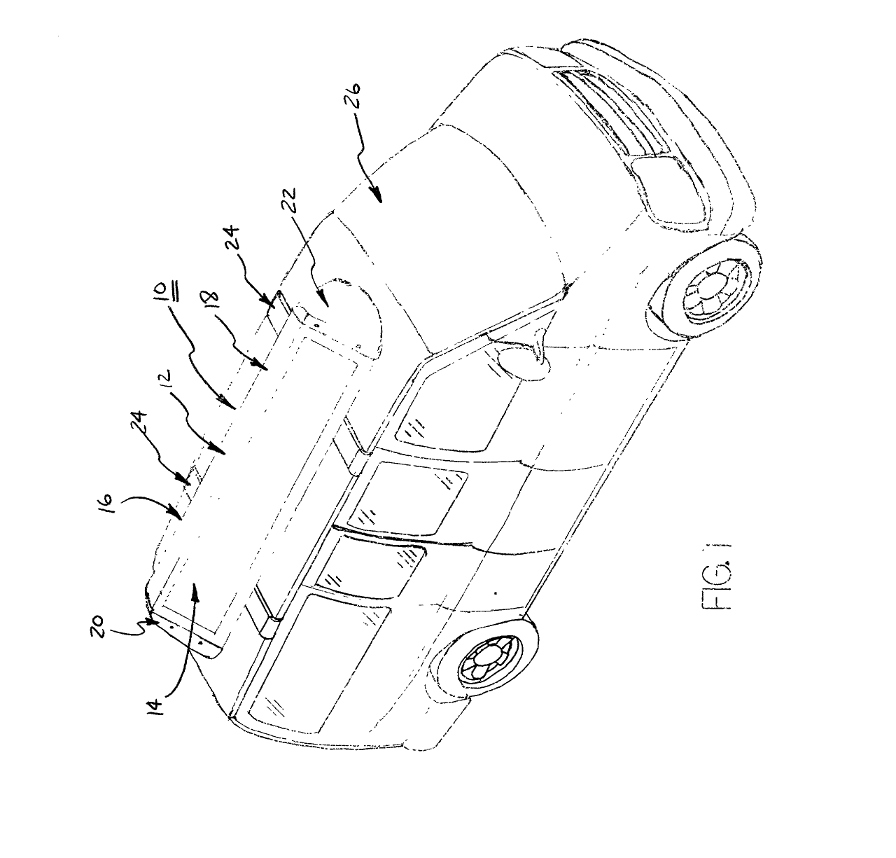

Referring now to FIG. 1, an advertising sign 10 generally includes a body 12 having a pair of sides 14, 16, a top 18, a pair of ends 20, 22, and a pair of mounting braces 24 to attach sign 10 to the vehicle 26.

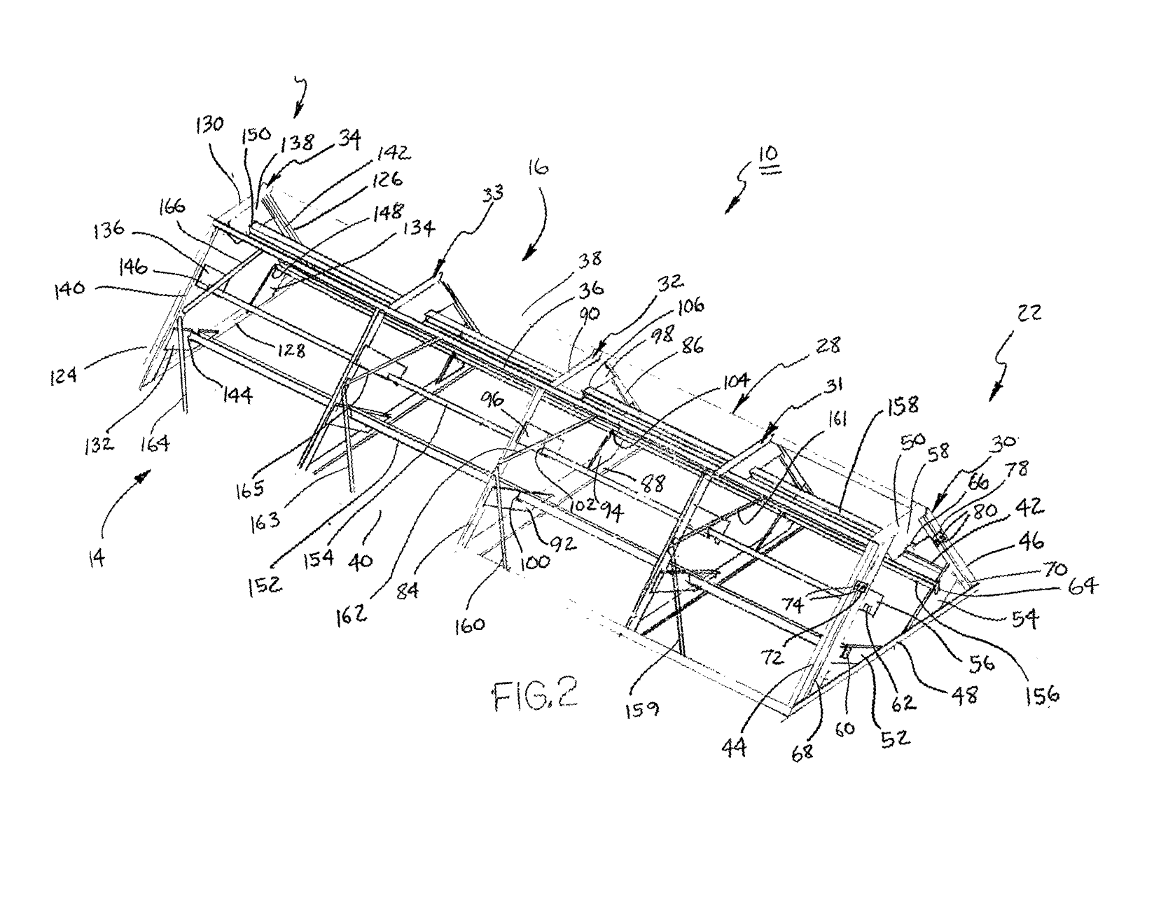

As best shown in FIG. 2, sign 10 further includes an internal support structure or frame 28 which generally includes a truss 30 at end 22, three trusses 31, 32, 33 between end 22 and end 20, a truss 34 at end 20, upper support rails 36, 38, and lower support rails 40, 42. Upper support rails 36, 38 include downwardly facing longitudinal grooves (not shown). Lower support rails 40, 42 include corresponding upwardly facing longitudinal grooves (not shown). As shown, support rails 36, 38, 40, 42 extend between end 20 and end 22 and connect trusses 30, 31, 32, 33, 34. The opposing longitudinal grooves of upper support rail 36 and lower support rail 40 receive and support an advertising panel as further described below. Likewise, the opposing grooves of support rails 38 and 42 receive and support an advertising panel.

Truss 30 includes angled members 44, 46, lower member 48, upper member 50, lower braces 52, 54, and upper braces 56, 58. Angled members 44, 46 extend between lower member 48 and upper member 50 at opposing angles to form a triangular shape. Lower brace 52 extends between lower member 48 and a lower portion of angled member 44. Similarly, lower brace 54 extends between lower member 48 and a lower portion of angled member 46. Upper brace 56 extends from angled member 44 in substantially parallel relationship to lower brace 52. Similarly, upper brace 58 is substantially parallel to lower brace 54 and connects angled members 44, 46 and upper member 50.

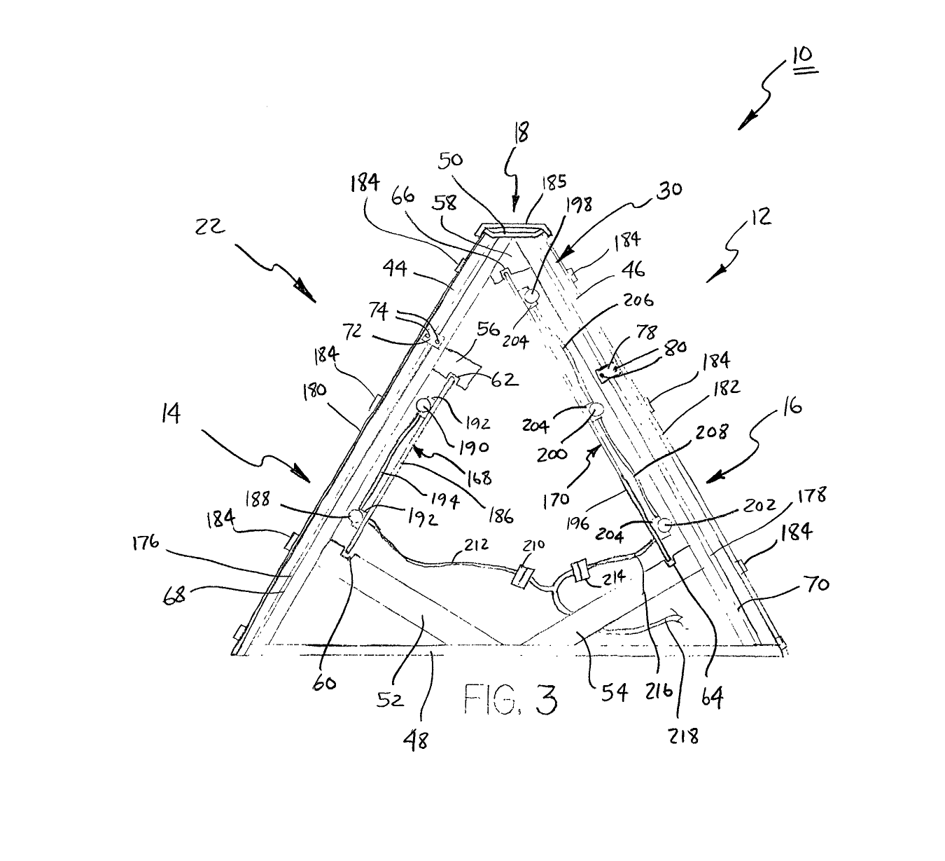

Lower brace 52 includes a notch 60 at one end which is spaced apart from angled member 44 by a distance substantially equal to the distance between angled member 44 and an opposing notch 62 on upper brace 56 as best shown in FIG. 3. Similarly, lower brace 54 includes a notch 64 at one end which is spaced apart from angled member 46 by a distance which is substantially equal to the distance of the spacing between angled member 46 and an opposing notch 66 on upper brace 58. Angled member 44 includes a longitudinally extending slot 68 extending between lower member 48 and upper member 50. Similarly, angled member 46 includes a longitudinally extending slot 70 which extends between lower member 48 and upper member 50. A plate 72 is mounted to angled member 44 with a pair of fasteners 74 which extend into threaded openings (not shown) in angled member 44. Angled member 46 also includes a plate 78 connected to angled member 46 with fasteners 80 in a similar manner.

Trusses 31, 32, 33, and 34 are dimensioned in substantially the same way as truss 30 to form or define the outside dimensions of frame 28. Trusses 31, 32, and 33 are substantially identical. Thus, only truss 32 is described below to simplify the description of the invention. Truss 32 includes angled members 84, 86, lower member 88, upper member 90, lower braces 92, 94, and upper braces 96, 98. Lower brace 92 includes a notch 100 which is spaced apart from angled member 84 by a distance substantially equal to the distance between angled member 84 and an opposing notch 102 on upper brace 96. The spacing between notches 100, 102 and angled member 84 correspond to the spacing between notches 60, 62, and angled member 44. Likewise, lower brace 94 includes a notch 104 and upper brace 98 includes a notch 106. The spacing between notches 104 and 106 relative to one another and relative to angled member 86 is substantially equal to the spacing between notches 64, 66 relative to one another and relative to angled member 46.

Truss 34 at end 20 of frame 28 similarly includes angled members 124, 126, lower member 128, upper member 130, lower braces 132, 134, and upper braces 136, 138. Angled member 124 includes a longitudinally extending groove 140 which extends between lower member 128 and upper member 130. Angled member 126 also includes a longitudinally extending groove 142 which extends between lower member 128 and upper member 130. Longitudinally extending grooves 140, 142 extend into but not through angled members 124, 126, respectively. Opposing notches 144 (on lower brace 132) and 146 (on upper brace 136) are spaced from each other and from angled member 124 in a manner similar to that described in the discussion of trusses 30 and 32. Likewise, opposing notches 148 (on lower brace 134) and 150 (on upper brace 138) are spaced apart from each other and from angled member 126 in a manner similar to that described in the discussion of trusses 30 and 32.

A channel 152 extends between end 22 and end 20, and is situated within notches 60, 100, 144 and the unlabeled notches of trusses 31, 33. An opposing channel 154 similarly extends between end 20 and end 22 and is situated within notches 62, 102, 146 and the unlabeled notches of trusses 31, 33. Channels 156, 158 are similarly disposed on side 16 of frame 28.

A ramp 160 is connected between an inwardly facing side of lower support rail 40 and an outwardly facing side of angled member 84 of truss 32. A ramp 162 similarly extends from an inwardly facing side of upper support rail 36 to an outwardly facing side of angled member 84. Ramps 160, 162 each terminate at a location on angled member 84 substantially centered between lower support member 40 and upper support member 36. Ramps 159, 161 and ramps 163, 165 are similarly mounted to trusses 31, 33, respectively. A ramp 164 extends from an inwardly facing side of lower support member 40 to a location on angled member 124 substantially centered between lower support member 40 and upper support member 36 adjacent the inner edge of groove 140. A ramp 166 similarly extends from an inwardly facing side of upper support member 36 to a location on angled member 124 adjacent the location of attachment of ramp 164. It should be understood that a plurality of ramps (not shown) are connected on side 16 of frame 28 to each of trusses 31, 32, 33, and 34 in a manner similar to the attachment of the ramps described above.

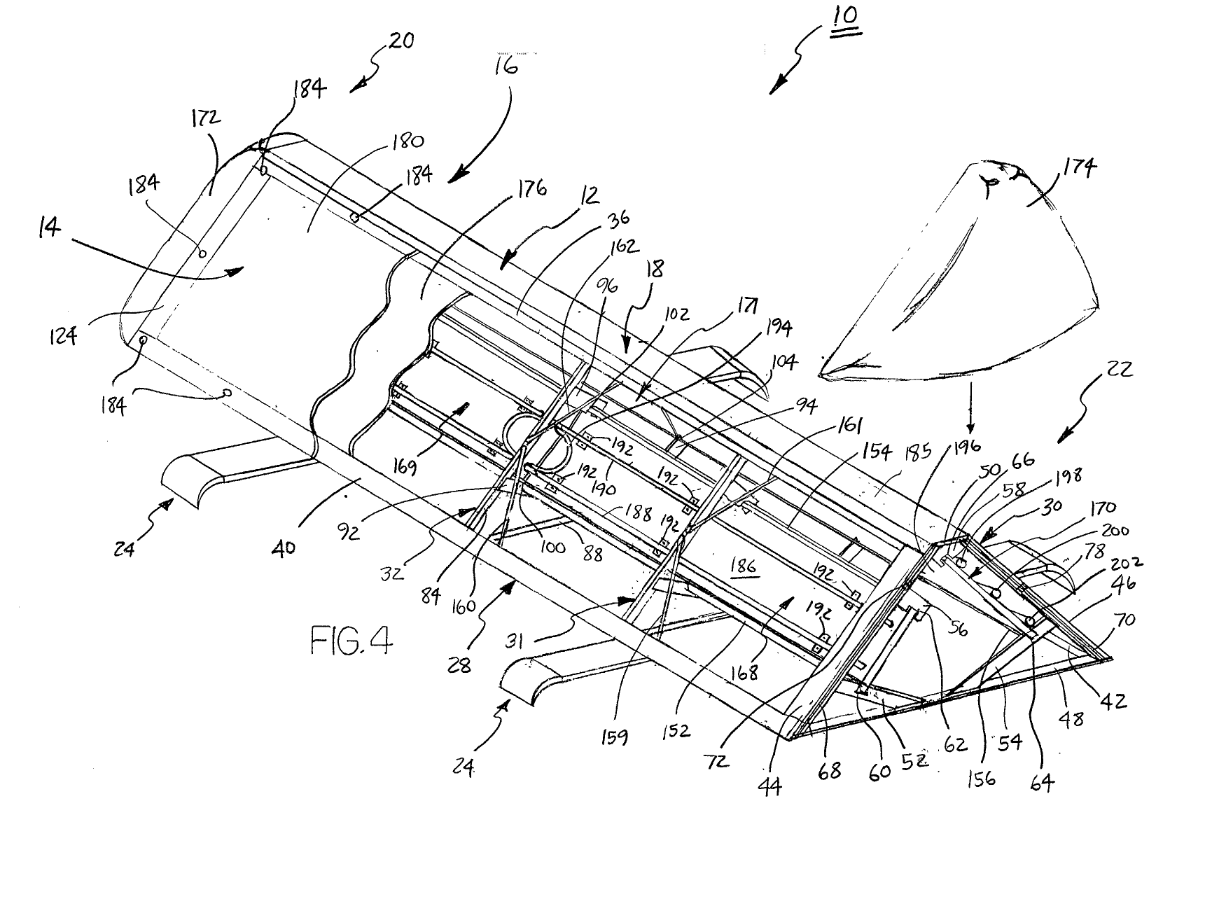

Referring now to FIGS. 3 and 4, sign 10 further includes lighting cartridges 168, 169, 170, 171, end caps 172, 174 which are fastened using conventional fasteners (not shown) to ends 20, 22, respectively, advertising panels 176, 178, and transparent covers 180, 182. Each mounting brace 24 includes a cross member 175 which is attached to frame 28 and a pair of end clips 177 connected to cross member 175. Clips 177 engage an upper edge of vehicle 26 as shown in FIG. 1. Braces 24 may further be adjustable in a manner well known to those skilled in the art. Transparent covers 180, 182 are fastened to frame 28 using fasteners 184 which are screwed into threaded openings (not shown) formed in angled members 44, 46, 124, 126, upper support rails 36, 38, and lower support rails 40, 42. A top cap 185 is attached to frame 28 along top 18, and overlaps the upper edges of covers 180, 182 as best shown in FIG. 3. Advertising panels 176, 178 are inserted into slots 68, 70, respectively, formed in angled members 44, 46, at end 22 as will be further described below.

Lighting cartridge 168 includes a plate 186 which slides into channels 152, 154 (FIG. 4) through end 22 of sign 10. Lighting cartridge 168 further includes a pair of lights or bulbs 188, 190, such as neon bulbs, which extend in parallel relationship to one another between truss 30 and truss 32. Bulbs 188, 190 are attached to plate 186 using brackets 192 and conventional fasteners. Tubing 194 connects bulbs 188, 190 for simultaneous operation. Lighting cartridge 169 is substantially identical to lighting cartridge 168, but is inserted through end 20 of sign 10 into channels 152, 154. Accordingly, lighting cartridge 169 extends between truss 34 and truss 32.

Lighting cartridge 170 similarly includes a plate 196 which is sized to fit within channels 156, 158 through end 22 of sign 10. Lighting cartridge 170 further includes bulbs 198, 200, 202 which are spaced in parallel relationship to one another and extend substantially the entire length of plate 196 between trusses 30 and 32. Bulbs 198, 200, 202 are attached to plate 196 using brackets 204 (FIG. 3) and conventional fasteners (not shown). Bulb 198 is connected to bulb 200 using tubing 206, and bulb 200 is connected to bulb 202 using tubing 208. Lighting cartridge 171 is substantially identical to lighting cartridge 170, but is inserted through end 20 and extends between truss 34 and truss 32 in channels 156, 158.

As shown in FIG. 3, lighting cartridge 168 is connected to a connector 210 by wires 212. Lighting cartridge 170 is similarly connected to a connector 214 by wires 216. Connectors 210 and 214 are connected together and to a power source (not shown) by wires 218. Lighting cartridges 169, 171 are connected together and to a power source in a similar manner.

As best shown in FIG. 3, bulbs 188, 190 and bulbs 198, 200, 202 are supported on plates 186, 196, respectively, such that the bulbs are substantially evenly spaced vertically. Bulbs 190 and 200 lie in substantially the same horizontal plane, and bulbs 188, 202 lie in substantially the same horizontal plane. The distance between all of the bulbs and their respective advertising panel 176, 178 is also substantially the same. By supporting the bulbs in this manner behind advertising panels 176, 178, lighting cartridges 168, 170 of the present invention provide relatively even rumination of advertising panels 176, 178, without noticeable dim spots or poorly lit areas on advertising panels 176, 178.

Referring again to FIGS. 3 and 4, any of lighting cartridges 168, 169, 170, 171 may be removed from frame 28 with minimum disassembly of sign 10. Specifically, lighting cartridges 168, 170 may be removed for repair by removing cover 174, disconnecting the appropriate connector 210, 214, and withdrawing the lighting cartridge 168, 170 through end 22 of sign 10. Lighting cartridges 169, 171 may be similarly removed by removing cover 172, disconnecting the electrical connections to lighting cartridges 169, 171, and withdrawing the desired cartridge through end 20 of sign 10.

Advertising panels 176, 178 are similarly removed from sign 10 for replacement with new advertising panels with minimal disassembly of sign 10. Specifically, advertising panel 176 may be removed by removing cover 174 and plate 72 which retains advertising panel 176 in place. When plate 172 is removed by removing fasteners 74, advertising panel 176 may be slid outwardly through slot 68 of end 22. Advertising panel 178 may be removed in a similar fashion by removing plate 78.

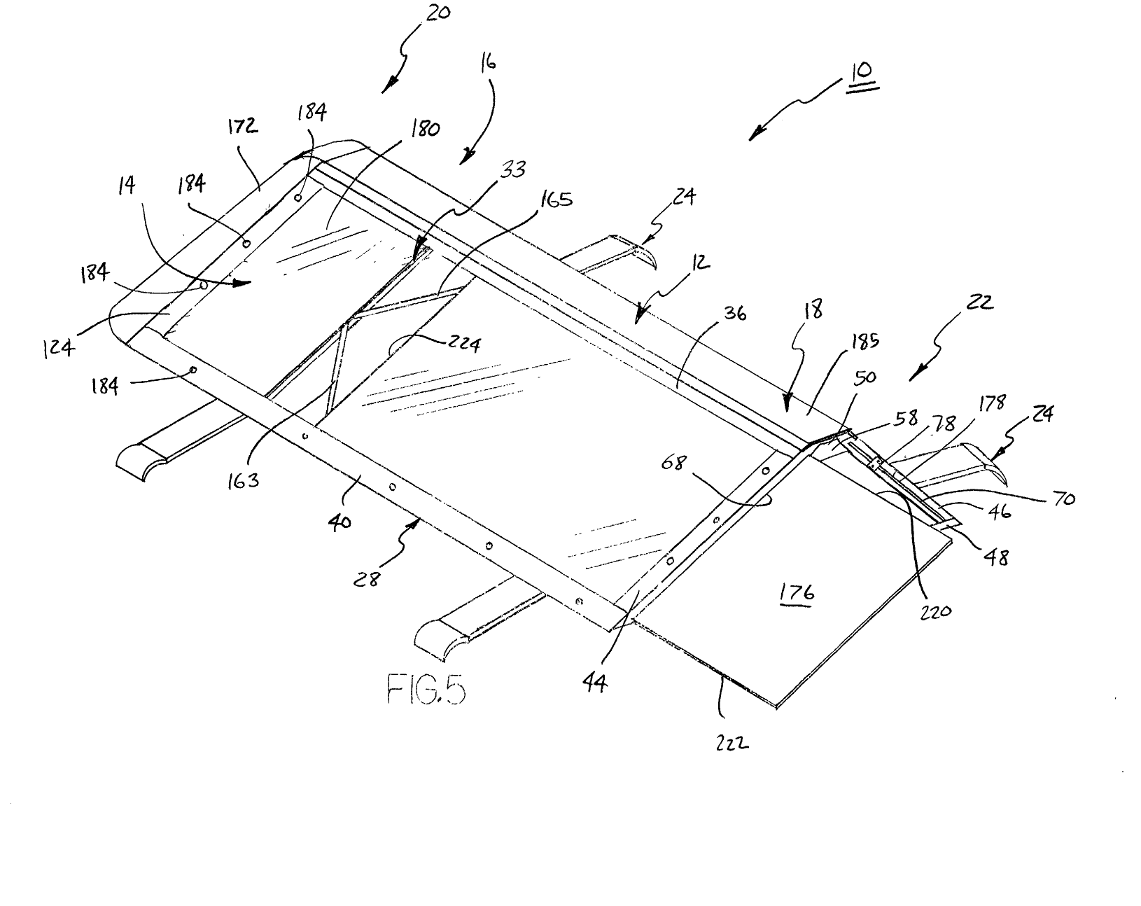

Referring now to FIG. 5, advertising panel 176 is installed in sign 10 by sliding panel 176 into slot 68. As panel 176 is further slid to the left (as viewed in FIG. 5), it is supported along its upper edge 220 by the groove (not shown) formed in upper support rail 36 and along its lower edge 222 by the groove (not shown) formed in lower support rail 40. Panel 176 may be formed of semi-flexible material, and therefore may have a tendency to bow inwardly under its own weight during installation. As such, the center portion of the leading edge 224 of panel 176 substantially midway between edges 220, 222 may tend to engage trusses 31, 32, 33 as panel 176 is inserted into sign 10. Ramps 159, 160, 161, 162, and 163, 165 prevent interference between leading edge 224 of panel 176 and trusses 31, 32, and 33. Specifically, as leading edge 224 of panel 176 approaches a truss, such as truss 33 as shown in FIG. 5, ramps 163, 165 associated with truss 33 guide leading edge 224 over truss 33 to prevent interference. Ramps 164, 166 of truss 34 (FIG. 2) similarly guide leading edge 224 of panel 176 into groove 140 of angled member 124. Panel 178 is installed in a similar fashion.

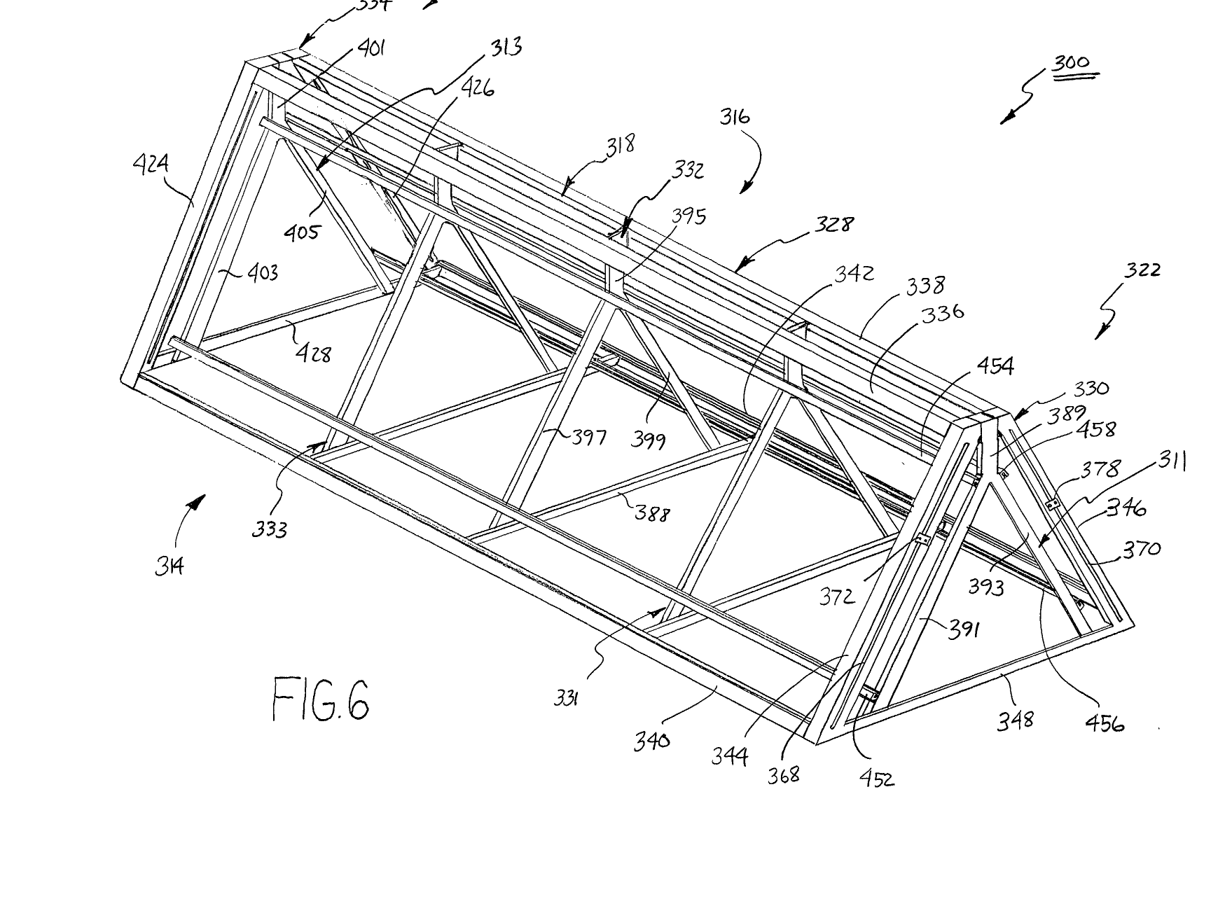

Referring now to FIG. 6, an alternate frame structure is shown. Frame 328 is similar in several regards to frame 28 shown in FIG. 2. Accordingly, common components have retained their original reference designations, increased by 300. Frame 328 generally includes a truss 330 at end 322, three trusses 331, 332, 333 between end 322 and end 320, a truss 334 at end 320, upper support rails 336, 338, and lower support rails 340, 342. Upper support rails 336, 338 include downwardly facing longitudinal grooves (not shown). Lower support rails 340, 342 include corresponding upwardly facing longitudinal grooves (not shown). As shown, support rails 336, 338, 340, 342 extend between end 320 and end 322 and connect trusses 330, 331, 332, 333, 334, and the opposing longitudinal grooves of upper support rail 336 and lower support rail 340 receive and support an advertising panel in the same manner as that described above with reference to frame 28. Likewise, the opposing grooves of support rails 338 and 342 receive and support an advertising panel.

Like truss 30 of FIG. 2, truss 330 includes angled members 344, 346, and lower member 348. Angled members 344, 346 extend between lower member 348 and upper support rails 336, 338, respectively, at opposing angles to form a triangular shape. Truss 330 further includes an inner truss including a vertical member 389 disposed between angled members 344, 346, and a pair of angled supports 391, 393 which extend at opposing angles between lower member 348 and vertical member 389. Angled members 344, 346 includes a longitudinally extending slots 368, 370 similar to slots 68, 70 of frame 28. Similarly, plates 372, 378 are mounted to angled members 44, 46, respectively.

Trusses 331, 332, 333, and 334 are dimensioned in substantially the same way as truss 330 to form or define the outside dimensions of frame 328. Trusses 331, 332, and 333 are substantially identical. Thus, only truss 332 is described below to simplify the description of the invention. Truss 332 is essentially identical to inner truss 311 and includes vertical member 395, angled supports 397, 399, and lower member 388. Lower member 388 extends between lower support rails 340, 342, and angled supports 397, 399 extend at opposite angles between vertical member 395 and lower member 388.

Truss 334 at end 320 of frame 328 is identical to truss 330, including an inner truss 313 having a vertical member 401, and angled supports 403, 405.

A channel 452 is connected to and extends across angled support 391 of truss 330, trusses 331, 332, 333, and angled support 403 of truss 334 between end 322 and end 320 adjacent lower support rail 340. An opposing channel 454 similarly extends between end 320 and end 322 and is situated adjacent upper support rail 336. Channels 456, 458 are similarly disposed on side 316 of frame 328.

Lighting cartridges (not shown) similar to those described with reference to FIGS. 3 and 4 are supported within channels 452, 454, 456, 458. Angled supports 391, 397, 403 (two not numbered) prevent inward bowing of the lighting cartridges during operation. It should be understood that the lighting cartridges may be inserted from either end 320, 322 to meet adjacent truss 332. It should be further understood that, unlike lighting cartridges 168 and 169, all four of the lighting cartridges for use with frame 328 include three bulbs spaced from top to bottom in a manner similar to bulbs 198, 200, 202 of lighting cartridge 170. As such, all lighting cartridges for use with frame 328 are substantially identical to one another.

As shown in FIG. 6, the opposing grooves of support rails 336, 340 and 338, 342 receive and support advertising panels as described above. No additional supports for the advertising panels are provided. Consequently, no structure exists between the lighting cartridges (when mounted within channels 452, 454, 456, 458) and the advertising panels to create shadows or dark spots.

Regarding both embodiments described above, it should be understood that a reflective coating is preferably applied to the side of the lighting cartridges (when mounted) facing the advertising panels. This coating, which may simply be white paint, provides improved brightness.

Although the present invention has been shown and described in detail, the same is to be taken by way of example only and not by way of limitation. Numerous changes can be made to the embodiments described above without departing from the scope of the invention. For example, one skilled in the art could employ fluorescent lights as the bulbs described above by incorporating a ballast with a step up transformer or inverter to convert the 12 volt power provided by vehicle batteries to the 110 volt level required by such lighting fixtures. Accordingly, the scope of the present invention is to be limited only by the terms of the claims appended hereto.

What is claimed is:

1. A vehicle-mounted advertising sign including:
a frame having two ends and two sides facing different directions;
a light located between the sides; and
a pair of slots formed on one of the ends to allow insertion and removal of a pair of advertising panels through the one end, each slot being adjacent a different one of the sides.

2. The sign of claim 1 including a pair of transparent covers connected to the sides, the advertising panels being disposed between the light and the covers when inserted into the sign.

3. The sign of claim 1 including a lighting cartridge mounted between the sides for removal and insertion though one of the ends, the light being mounted to the lighting cartridge.

4. The sign of claim 1 including a plurality of trusses defining the frame.

5. The sign of claim 4 including a plurality of ramps mounted to the frame adjacent the plurality of trusses, the ramps guiding the advertising panels over the trusses as the advertising panels are inserted into the sign.

6. The sign of claim 1 wherein the light is a neon bulb.

7. The sign of claim 1 including a plurality of lighting cartridges carrying a plurality of lights, each lighting cartridge being supported by the frame in substantially parallel relationship to an advertising panel.

8. The sign of claim 7 wherein one lighting cartridge is removable through one of the ends and another lighting cartridge is removable through the other end.

9. The sign of claim 1 including a mounting brace connected to the frame, the mounting brace including a pair of clips for holding the sign to the vehicle.

10. The sign of claim 1 wherein the frame has a substantially triangular cross section.

11. The sign of claim 7 wherein the distance between adjacent lights is substantially uniform to illuminate the advertising panels in a uniform manner.

12. A vehicle-mounted advertising sign including:
a frame having first and second ends;
two advertising panels supported by the frame; and
a first lighting cartridge supported by the frame between the advertising panels, the lighting cartridge being removable through one of the ends.

13. The sign of claim 12 wherein the frame includes a first channel and a second channel, the lighting cartridge being held in position by the first and second channels.

14. The sign of claim 12 wherein the frame includes two sides, each side extending between the first and second ends, each of the advertising panels being located on a respective side.

15. The sign of claim 12 including two transparent covers, each cover being connected to the frame to cover an advertising panel.

16. The sign of claim 12 wherein the lighting cartridge includes a neon bulb.

17. The sign of claim 12 wherein one of the ends includes a pair of slots for receiving the advertising panels.

18. The sign of claim 12 including a mounting brace connected to the frame, the mounting brace including a pair of clips for holding the sign to the vehicle.

19. The sign of claim 12 including a second lighting cartridge, each lighting cartridge being supported by the frame adjacent an advertising panel and in substantially parallel relationship thereto.

20. The sign of claim 19 wherein the first lighting cartridge includes a first bulb, a second bulb, and a third bulb, and the second lighting cartridge includes a fourth bulb and a fifth bulb.

21. The sign of claim 20 wherein the five bulbs are arranged on the lighting cartridges to provide substantially uniform lighting of the advertising panels.

22. The sign of claim 20 wherein the first bulb lies in a first horizontal plane, the second and fourth bulbs lie in a second horizontal plane, and the third and fifth bulbs lie in a third horizontal plane, the horizontal planes being substantially equally spaced from one another.
